(19) United States
(12) Patent Application Publication
(10) Pub. No.: US 2016/0218593 A1
(43) Pub. Date: Jul. 28, 2016

(54) Method and System for implementing a micro integrated gasification combined cycle

(71) Applicant: Michael C. Cheiky, Thousand Oaks, CA (US)

(72) Inventor: Michael C. Cheiky, Thousand Oaks, CA (US)

(73) Assignee: V-Grid Energy Systems, Inc., Camarillo, CA (US)

(21) Appl. No.: 15/006,916

(22) Filed: Jan. 26, 2016

Related U.S. Application Data
(60) Provisional application No. 62/108,432, filed on Jan. 27, 2015.

(51) Int. Cl. H02K 7/18; F02G 5/02

(52) U.S. Cl. CPC H02K 7/1823; F02G 5/02

(57) ABSTRACT

Renewable electricity, such as from solar or wind, powers a topping cycle utilizing combustion energy electricity generation, such that the electricity output of the system exceeds the combined standalone outputs. Renewable carbon, such as from biomass, can also power a similar topping cycle, having the same effect.

### FIELD OF THE DISCLOSURE

The disclosure broadly relates to renewable electricity, and more particularly, to a topping cycle that utilizes combustion energy electricity generation, such that the electricity output of the system exceeds the combined standalone outputs.

### BACKGROUND OF THE DISCLOSURE

As world population continues to grow, more diversification in the use of natural resources is desired. In particular, a sustainable approach that encompasses greater use of solar, wind, and biomass resources is sought to face oncoming challenges of supplying a growing population with its increasing power needs. A problem with current implementations of solar and wind resources is that they are not readily available when most needed, i.e., they are not dispatchable. On the other hand, surplus solar and wind electricity tend to remain unused and methods to store this electricity via batteries, for example, are expensive. Biomass is a relatively inexpensive dispatchable source of energy. An approach of integrating surplus renewable energy with biomass is desired.

Cogeneration plants which serve to turn biomass or other feedstock to electricity and heat are well known. Cogeneration plants which use a combined cycle (CC), link a Brayton to a Rankine cycle to achieve higher efficiencies through the use of waste heat delivered from a gas turbine to power a steam turbine. An advantage of cogeneration plants using a combined cycle approach is that efficiencies of plants are doubled compared to the simpler steam boiler plants. Current CC plant efficiencies are around 40% for commercially operating power plants in the United States and Spain.

There is substantial capital cost associated with the turbines and generators used in these plants, however, and these plants need to be operated on a continuous load basis. Cogeneration plants using a single cycle, such as coal-based power plants (the most numerous plants in operation today), typically achieve electrical efficiencies around 10-25% through the use of subcritical steam cooled gas turbines. Natural gas efficiencies are somewhat higher, according to U.S. Energy Information Administration.

Efforts are being made to increase the renewable component in electricity production throughout the world, in particular by wider deployment of cogeneration plants that utilize biomass as co-fuel. An attractive feature of using biomass is the rendering of electricity production carbon neutral. It is desirable to transfer aspects of combined cycle to decentralized small scale power systems. In particular, efficient portable server units that avail themselves of the efficiencies of a combined cycle, utilize dispatchable biomass, and exploit surplus renewable electricity are desired.

Integrated gasification combined cycle (IGCC) plants utilize gasifiers for syngas production, and this syngas is combusted in a combined cycle operation. The basic elements of a coal-based IGCC power plant are as follows. Coal slurry along with compressed air is fed to a gasifier which produces syngas typically comprised of a mixture of H₂, CO, CO₂, H₂O, CH₄, N₂ and small quantities of hydrocarbons and H₂S. The hot syngas exiting the gasifier is cooled via a radiant cooler and directed to scrubbers and filters comprising the syngas cleanup process. Clean syngas is fed to a gas turbine along with compressed air, at which point electricity is generated when the syngas is combusted and electricity is generated via rotary motion of a set of turbines. Exhaust heat out of the turbine is directed to a heat recovery unit which then directs heat to a steam turbine which also produces electricity. Thus there are two heat conversion mechanisms, one for high grade heat (out of the gas turbine) and one for the low grade heat (out of the steam turbine). This combined cycle plant is called a topping cycle plant. When carbon dioxide is captured via sorbents and released to be sequestered in geologic formations the processed is called carbon capture and sequestration (CCS).

In the present disclosure a cogeneration plant serves as a partial source of energy to indirectly heat an exterior gasifier. Indirectly heated gasifiers are known. In a power system design by Battelle, Inc. as disclosed in U.S. Pat. No. 4,828,581, an entrained flow gasifier receives biomass as input and steam as the gasification medium, while a separate combustion chamber receives oxygen and char. The combusted char supplies energy to the first gasifier. Sand is used as the transfer medium between the gasifier and the char combustor. A tar cracker is used to eliminate tar resulting from the gasification. All the gasification energy comes from the input biomass and there is no non-thermal energy input to the char combustor or the gasifier.

Another gasifier indirect heating scheme is the separate chamber design as delineated by Cortus Energy in U.S. Pat. No. 8,617,268. In this gasification scheme gaseous flow and solid flow are separated by having three separate chambers, one for biomass drying, another for pyrolysis and yet another for char gasification. Pryrolysis gas and char are routed via separate streams to a gasifying chamber which also receives steam as an input. The pyrolysis step is performed at 400-500 C, while gasification occurs at 1100 C. The producer gas combustion and radiant heat from the pyrolysis step provide the energy for the gasification.

### SUMMARY OF THE DISCLOSURE

Embodiments of the present disclosure link idle power from renewable power plants, carbon from internal or external sources, and waste heat from a cogeneration plant to enable greater electricity production via gasification. The present disclosure represents an innovative method for storing energy from renewable sources and utilizing it in high efficiency power conversion systems. It further represents a novel pathway for a topping cycle cogeneration plant and a more efficient system integration of resources. Economical miniaturization of highly efficient combined cycle plants using natural gas or natural gas/biomass is realized. Implementation of gasification working at low pressures would save on capital costs of building additional large scale power plants. It is also represents a method for decarbonizing fossil-based methane.

The full nature of the advantages of the disclosure will become more evident from the following detailed description.

### BRIEF DESCRIPTION OF THE DRAWINGS

Certain embodiments of the present disclosure will hereinafter be described in detail, by way of example only, with reference to the accompanying drawings, in which:

FIG. 1a (prior art) is a schematic of a conventional cogeneration plant generating electricity and distributing process heat to ambient.

FIG. 1b (prior art) is a schematic of a conventional combined cycle plant in which feedstock is converted in a cogeneration plant to electricity and process heat, and the process heat is directed to a steam cycle which further generates electricity and process heat.

FIG. 2a illustrates an embodiment of the present disclosure in which a gasifier receives process heat, carbon, and water from a cogeneration plant, as well as external renewable electricity, and gasifier syngas output is directed to the cogeneration plant.

FIG. 2b illustrates another embodiment of the present disclosure in which a gasifier receives process heat from a cogeneration plant, but renewable electricity, carbon, and water are supplied externally, and gasifier syngas output is directed to the cogeneration plant.

FIG. 2c illustrates an embodiment of the present disclosure in which a gasifier receives process heat, carbon, and water from a first cogeneration plant, but syngas output from this gasifier is directed a second cogeneration plant.

FIG. 3 is a schematic showing generalized inputs and outputs for embodiments of the present disclosure.

FIG. 4 is a schematic of present disclosure illustrating the use of additional recycling of waste heat.

FIG. 5 is a schematic of present disclosure illustrating the use of a separate cogeneration plant for syngas output from gasifier.

FIG. 6a is a diagram showing graphs of product yields versus temperature for various relevant gasification reactions.

FIG. 6b shows the pressure dependence of relevant gasification reactions.

FIG. 7 is a schematic of a simplified system embodiment of the present disclosure.

FIG. 8 illustrates the simplified system embodiment in FIG. 7, which exhibits a cogeneration plant feeding its exhaust to a gasifier which is also heated using renewable power via a resistive element.

FIGS. 9a-c illustrate systems for supplying external energy to the auxiliary gasifier, including resistive elements, carbon arc methods, and inductive coil methods, respectively, according to various embodiments of the disclosure.

FIGS. 10a-c illustrate possible different locations between the first gasifier and the second gasifier, according to various embodiments of the disclosure.

FIG. 11 shows an embodiment of a system which uses multiple auxiliary gasifiers, each using a separate gasifier reaction.

FIGS. 12a-b show calculations illustrating a 2× expected Coefficient of Electrical Performance (COEP).

FIG. 13 shows calculations illustrating a 3× COEP.

### DETAILED DESCRIPTION

In the following paragraphs, embodiments of the present disclosure will be described in detail by way of example with reference to the attached drawings. Throughout this description, the preferred embodiment and examples shown should be considered as exemplars, rather than as limitations on the present disclosure. As used herein, the “present disclosure” refers to any one of the embodiments of the disclosure described herein, and any equivalents. Furthermore, reference to various feature(s) of the “present disclosure” throughout this document does not mean that all claimed embodiments or methods must include the referenced feature(s).

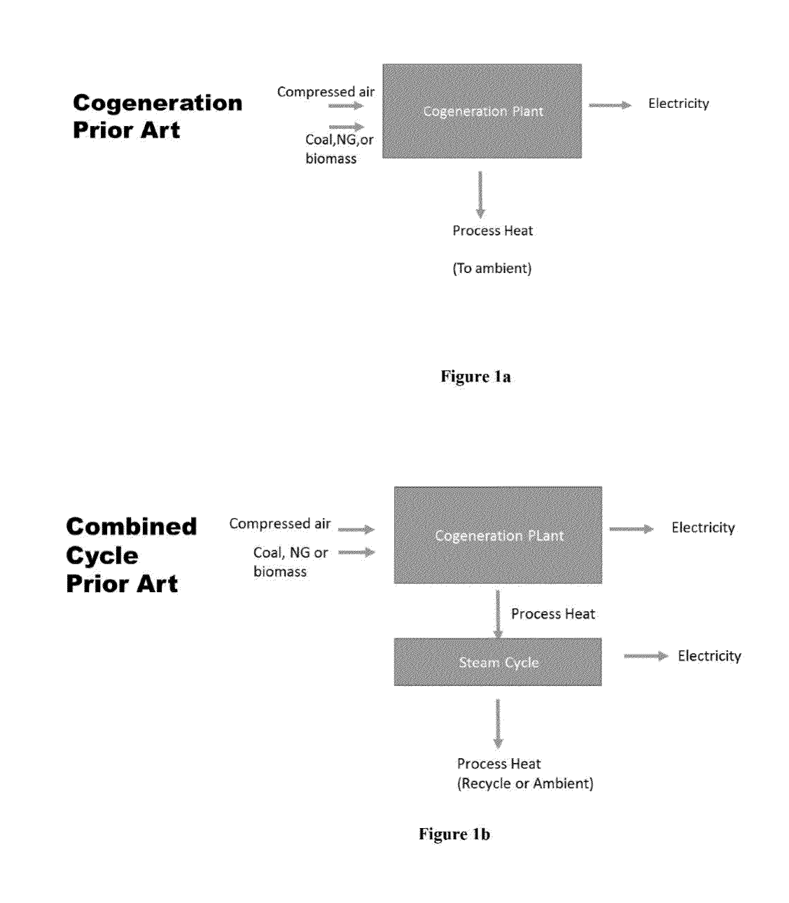

FIG. 1a (prior art) is a schematic of a conventional cogeneration plant generating electricity and distributing process heat to ambient. In the single cycle arrangement of FIG. 1a, a cogeneration plant that receives coal, natural gas, or biomass as feedstock can convert these feedstock to electricity and process heat using a heat engine. The process heat can be recycled to the cogeneration plant or wasted to ambient. FIG. 1b (prior art) is a schematic of a conventional combined cycle plant in which feedstock is converted in a cogeneration plant to electricity and process heat, and the process heat is directed to a steam cycle which further generates electricity and process heat. In FIG. 1b, displaying a combined cycle arrangement, a subsequent cycle is added which receives the process heat from the cogeneration plant and converts it to additional electricity and process heat.

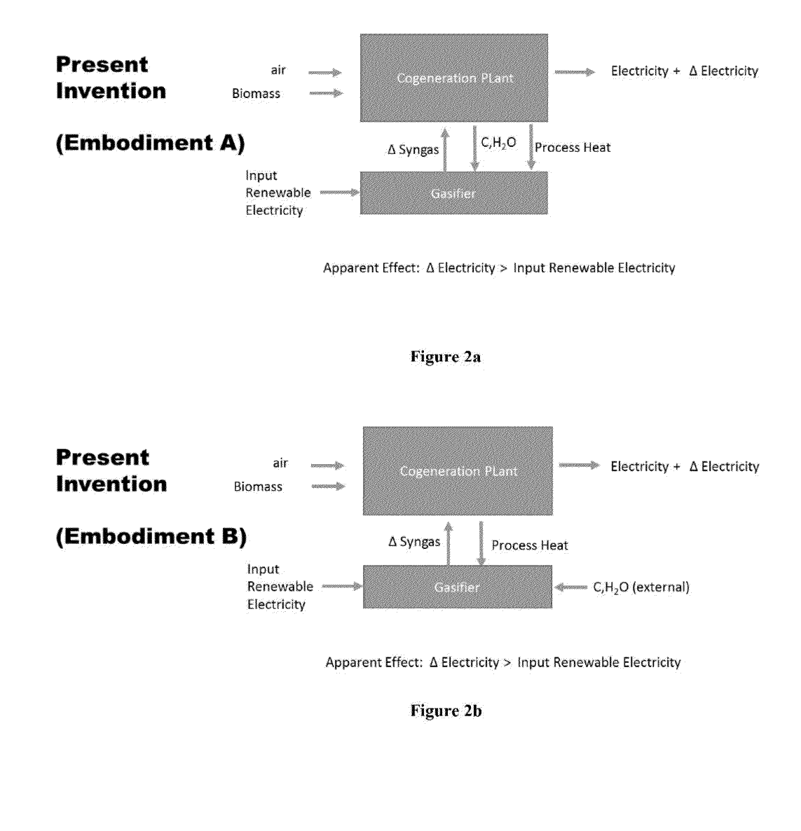

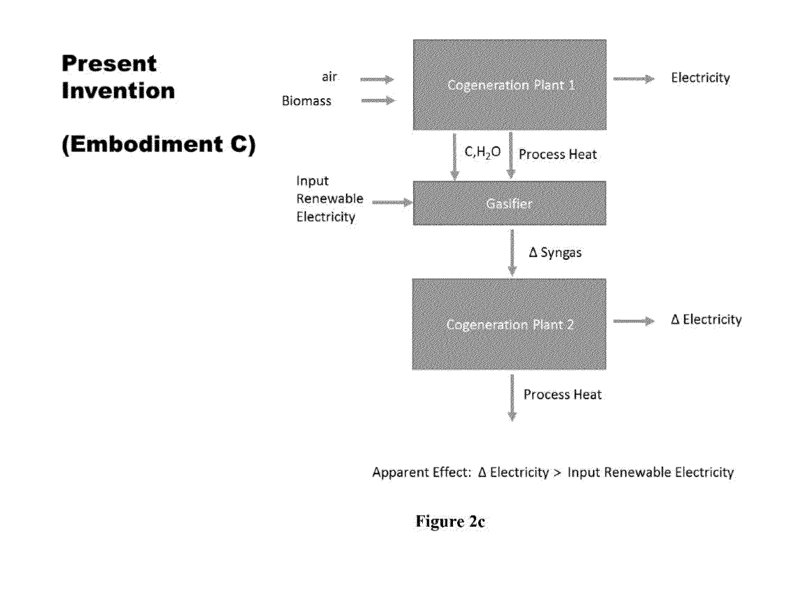

FIG. 2a illustrates an embodiment of the present disclosure in which a gasifier receives process beat, carbon, and water from a cogeneration plant, as well as external renewable electricity, and gasifier syngas output is directed to the cogeneration plant to produce an additional ΔElectricity. The apparent net effect, applicable to all 3 figures, is the conversion of the input renewable electricity to ΔElectricity, where by design ΔElectricity>input renewable electricity. FIG. 2b shows another embodiment of the present disclosure in which a gasifier receives process heat from a first cogeneration plant, but renewable electricity, carbon, and water are supplied externally, and gasifier syngas output is directed to the cogeneration plant. In the embodiment of FIG. 2c, a gasifier receives process heat, carbon, and water from a first cogeneration plant, but syngas output from this gasifier is directed a second cogeneration plant which converts this syngas to ΔElectricity and a second process heat.

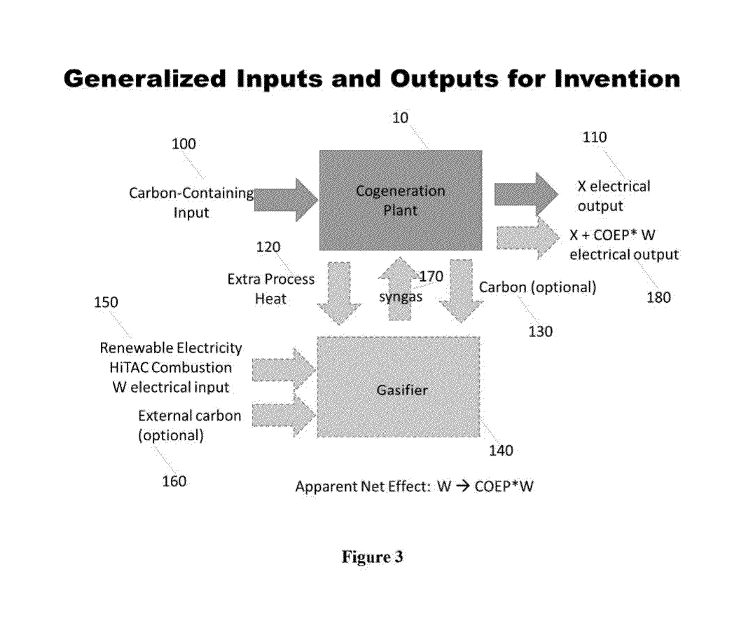

The possible inputs and outputs of the present disclosure are more fully shown in FIG. 3. In particular, a cogeneration plant 10 receives a carbon-containing fuel 100 such as natural gas, biogas, biomass, or a combination of natural gas and biomass, and produces an electrical output 110 of magnitude X, and process heat 120 along with optional carbon 130. The process heat is fed to gasifier 140 along with external energy source 150 of magnitude W and external carbon 160 to produce a syngas product 170 which is routed to cogeneration plant 10. The incorporation of the gasifier 140 and the external inputs 150 and 160 into the cogeneration plant enable the production of electricity output 180, which is now of magnitude X+COEP*W. COEP (for Coefficient of Electrical Performance), by analogy to the common term coefficient of performance, is defined as the amount of electrical energy generated per electrical energy input. The present disclosure teaches how the incorporation of the additional elements comprising the gasifier and external energy input can realize COEP values greater than 1.

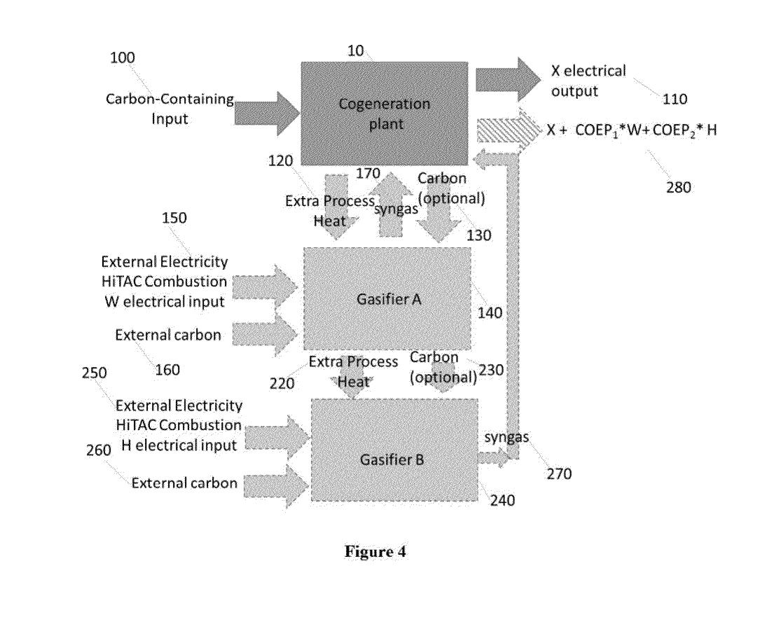

This basic framework can be replicated a plurality of times, by using waste heat from one process to feed a subsequent process. This replicability is exemplified by FIG. 4 which shows the input of process heat 220 from gasifier 140 being fed to gasifier 220. This gasifier also receives external energy source 250 of magnitude H, external carbon 260 and optional carbon 230. Syngas 270 from gasifier 220 is processed in cogeneration plant 10 to yield electricity of magnitude X+COEP(1)*W+COEP(2)*H, where the values of COEP(1) and COEP(2) are the coefficients of electrical performance for the first and second gasifier addition processes, respectively.

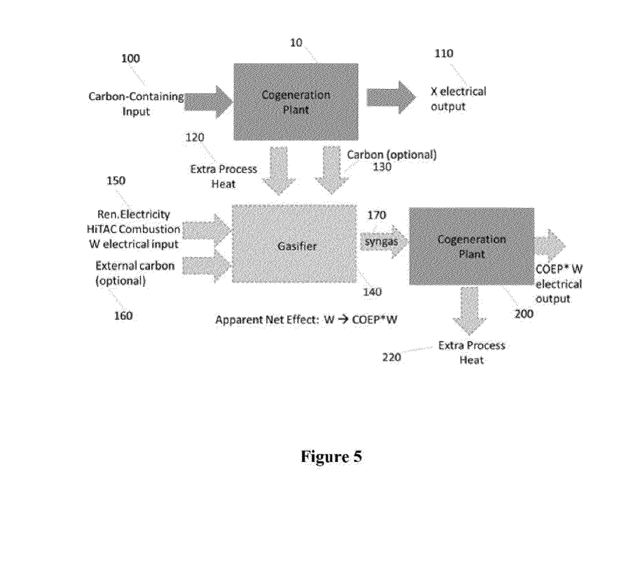

An alternate configuration of the present disclosure is presented in FIG. 5. Instead of directing syngas 170 back to cogeneration plant 10, the syngas is instead directed to a different cogeneration plant 200 which is able to produce electrical output COEP*W and waste heat 220. This waste heat in turn can be utilized in a different gasifier having separate inputs of renewable electricity and external carbon, and the process can be replicated a plurality of times.

The carbon-containing input 100 can be a material, gas, liquid or solid, or a mixture of materials, with a substantial fraction of carbon in its composition. This material may comprise part of a larger set of materials, some of which may have a small fraction or no fraction of carbon in its their composition. Carbon-containing input may comprise methane or methane-containing containing mixtures, such as natural gas, biogas, or landfill gas. The carbon-containing input may also comprise biomass, a term for the biodegradable fraction of agricultural products, residual or not, forestry products, industrial or municipal solid waste. Biomass generally refers to material originating from plant matter, in particular material containing cellulose, hemicellulose, lignins, lignocellulosic polymers, and extractives as composition. Forest products refers may refer to forest residue, wood pellets, wood shavings, bark, peat, waste wood, energy crops, virgin wood, recycled wood, sludge, sawdust, wood chips, as well as as black liquor and other products derived from pulp and paper operations. Biomass may also refer to herbaceous material such as miscanthus, rice husk, straw, and and sorghum as well as waste edible materials such as seeds and grains. Biomass may also refer to animal derived products such as manure. The term may also be used for a mixture of one or more of the above.

Industrial co-products may comprise biosolids, kitchen waste, medical waste, municipal solid waste, chemical waste, fabrics, plastic waste containing one of polyethylene, polypropylene, polyethylene terephthalate, polystyrene, polyvinyl chloride; tires and tire products, and fabrics.

The cogeneration plant 10 receiving carbon-containing input 100 serves to convert the input to electricity and useful heat. It comprises one or more heat engines and generators. The useful heat from the heat engine may be used in a variety of applications, some to produce electricity. Cogeneration plants include any topping cycle plants, and bottoming cycle plants. In particular, included are power plants supplying electricity and district heating, IGCC plants running on coal, biomass, or natural gas; CHP plants running gas turbines, steam turbines, rotary gas engines, reciprocating gas engines including internal and external combustion engines; plants running completely or partly on biomass such as wood pellets, plants using nuclear power, hybrid CHP plants running on solar power (ISCC, photovoltaic or concentrated) and natural gas, wind power and natural gas, hydrothermal power and coal; small scale CHP systems including microCHP system, trigeneration plants, and industrial cogeneration plants using boilers.

The extra process heat 120 may comprise 1-90% of the total chemical energy of input 100. In some embodiments, it may comprise 20-80% of the input energy, while in other embodiments it may comprise 30-70% of the input energy. Preferred embodiments comprise 20-50% of the input energy.

The optional carbon output 130 is a carbonaceous material that may arise from a pyrolysis or gasification process in a cogeneration plant. This carbonaceous product can be used in a subsequent gasifier 140 to effect various gasification reactions, such as gasification with steam, oxygen, carbon dioxide or hydrogen as follows:

C+H₂O→CO+H₂

C+CO₂→2 CO

C+½ O₂→CO

C+2H₂→CH₄

The carbon can be conveyed by various methods, such as transport in a moving conveyor, fine particle dispersal or pumped in slurry form. The external carbon source 160 can carbonaceous products such as charcoal, of renewable or fossil origin, biochar, activated carbon, or coal. Other carbon sources may derive from stranded natural gas, biogas, or landfill gas.

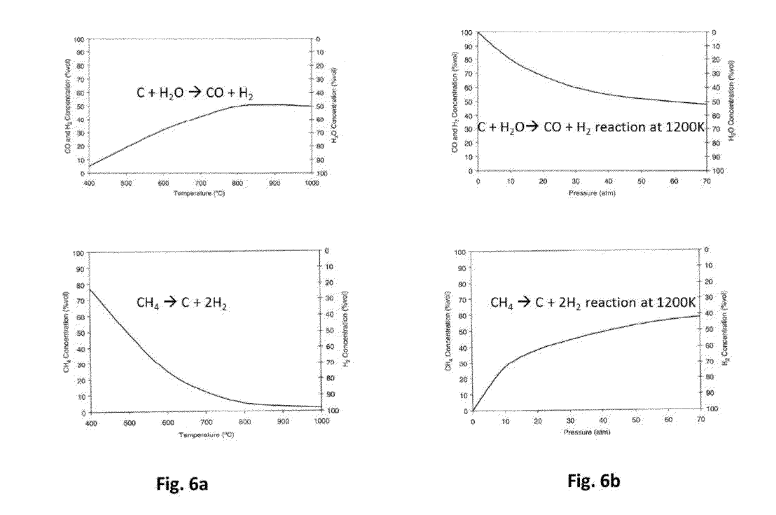

A notable feature of the present disclosure involves the utilization of both waste heat from the cogeneration plant and external high grade energy to power gasifier 140. By contrast, conventional gasifiers use just low grade energy for their operation. Gasifier reactions can be exothermic or endothermic, though most tend to be endothermic. Table 1 (below) lists common gasifier reactions along with enthalpies at various three different temperatures, and FIG. 6a shows product distributions for the water shift reaction and the methane decomposition reactions, according to Basu, Prabir in “Combustion and Gasification of Fluidized Beds”, CRC Press (2006). It is evident that at high temperatures above 700° C. the steam gasification and the methane decomposition reactions proceed to a significant extent. Waste heat from a heat engine used in a topping cycle is typically at temperatures of 400-500° C. and these temperatures are not sufficient for the gasification reactions to proceed to a significant extent. The pressure dependence of these reactions at 1200° K is shown in FIG. 6b. It is also evident that these reactions decrease as a function of increasing pressure and thus a more favorable regime for their occurrence is at low pressures.

TABLE 1

| | Standard | | | | | |
|---|---|---|---|---|---|---|
| | Enthalpy | Enthalpy | Enthalpy | | | |
| | 25° C. | 727° C. | 1227 C. | Log K | Log K | Log K |
| Reaction | (kJ/mole) | (kJ/mole) | (kJ/mole) | 25° C. | 727° C. | 1227° C. |
| C + 2H₂ → CH₄ | −75 | −89 | −94 | 8.9 | −1.0 | −2.6 |
| C + H₂O → CO + H₂ | +122 | | | | | |
| C + CO₂ → 2CO | +165 | | | | | |
| C + O₂ → CO₂ | −402 | −394 | −395 | 69.1 | 20.7 | 13.8 |
| C + ½ O₂ → CO | −110 | −112 | −116 | 24.1 | 10.5 | 8.5 |
| CO₂ + H₂ → CO + H₂O | +42 | | | | | |
| C + H₂O → CO + H₂ | −42 | | | | | |
| CO + 3H₂ → CH₄ + H₂O | −226 | | | | | |
| CO + 2H₂ → CH₃OH + H₂O | −105 | | | | | |
| H₂ + ½ O₂ → H₂O | −241 | −248 | −251 | 40.1 | 10.1 | 5.7 |
| CH₄ + → CO₂ → 2CO + 2H₂ | +268 | | | | | |

In the presence of methane, the steam reforming reaction is possible, as shown by the following equation:

CH₄+H₂O→CO+3H₂

A wide variety of gasifiers have been developed. Among the gasifiers suitable for the embodiments of the disclosure are the following: circulating fluidized bed or bubbling fluidized bed gasifiers, oxygen/steam/air blown gasifiers, fixed bed gasifiers, entrained flow gasifiers, and twin-bed gasifiers. The gasifier can be operated at atmospheric pressure or in pressurized mode.

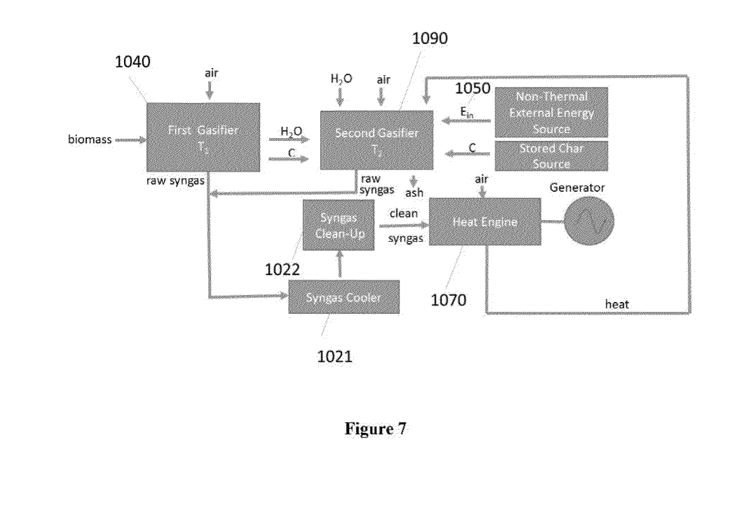

FIG. 7 illustrates an embodiment of the architecture shown in FIG. 3. Specifically, a simplified cogeneration plant is comprised of a first gasifier operating at temperature T₁, syngas cooler, syngas clean-up equipment, heat engine and generator. The first gasifier 1040 receives air and biomass as inputs. Gasification by the first gasifier produces raw syngas which is sent to the syngas cooler 1021 and syngas clean-up apparatus 1022 and then combusted in heat engine 1070. The heat from the combustion is converted to mechanical energy and this mechanical energy is converted to electricity by the generator. Waste heat from the heat engine is routed to a second gasifier 1090 operating at temperature T₂. This second gasifier is capable of receiving water and carbon outputs from first gasifier, as well as external water, air, carbon from a storage source, and external energy 1050 from a source such as wind mills or solar arrays. The combination of waste heat from the heat engine and external heat energy allow the second gasifier to attain temperature T₂ which allows the gasification reactions to proceed to a significant extent.

While it may seem paradoxical to use electricity to generate electricity, a novel aspect of the disclosure involves time shifting the availability of idle electricity via the chemical energy stored in carbon. The source of the external energy may be any source of high grade heat, such as that available from electricity derived from solar and wind power plants. Solar power plants may utilize technology using photovoltaics, concentrated solar power using Fresnel collectors or parabolic mirrors, and non-concentrated solar-thermal systems. Suitable wind power plants include utility-style wind farms, small scale distributed wind plants, and off-shore wind plants. The extra energy may also be derived from a high temperature air combustion (HITAC) process where the waste energy is at sufficiently high temperature to be useful.

As mentioned above, carbon may be introduced from either the first gasifier or an external source. The calorific value (HHV) of char is approximately 30 MJ/kg, which represents 8.3 kWh per kg of char. In the case of concurrent steam injection into the gasifier, the external energy and the waste heat enable the gasification of this carbon and subsequent syngas production for electricity production, thus effecting a conversion from electricity to chemical energy and back to electricity.

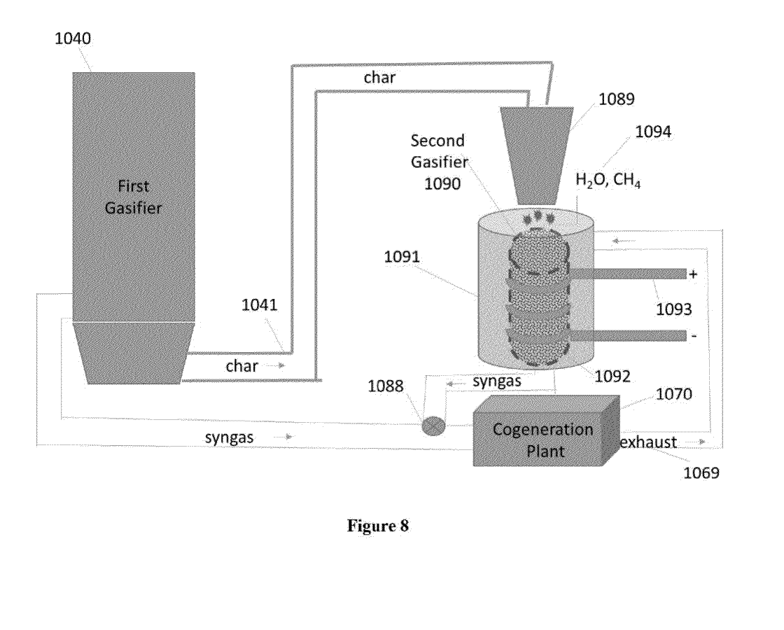

FIG. 8 illustrates an embodiment of the schematic in FIG. 7. In particular, the first gasifier 1040 is operated under conditions which produce both char 1041 and syngas 1042. This syngas is directed to cogeneration plant 1070 for electricity production and exhaust 1069. The char is directed via conduit 1043, which can be an auger assembly, for example, to hopper 1089 which feeds the second gasifier having shell 1092. Inputs of water and/or methane 1094 are also shown as being fed to the second gasifier. The second gasifier shell is wrapped around heating wire 1093 which is powered by external source of energy 1050 in FIG. 6. The second gasifier along with the electrical heating wire are enclosed within a larger container 1091 capable of receiving exhaust heat 1069 from cogeneration plant 1070. If the heat engine is an internal combustion engine, the exhaust heat is at a temperature around 400° C., so that the electrical heating would need to elevate the second gasifier temperature by at least 300° C. to significantly drive the formation of syngas 1043. A one-way valve 1088 allows this syngas 1043 to be mixed with syngas 1042, both not necessarily of the same composition, for subsequent combustion in the heat engine.

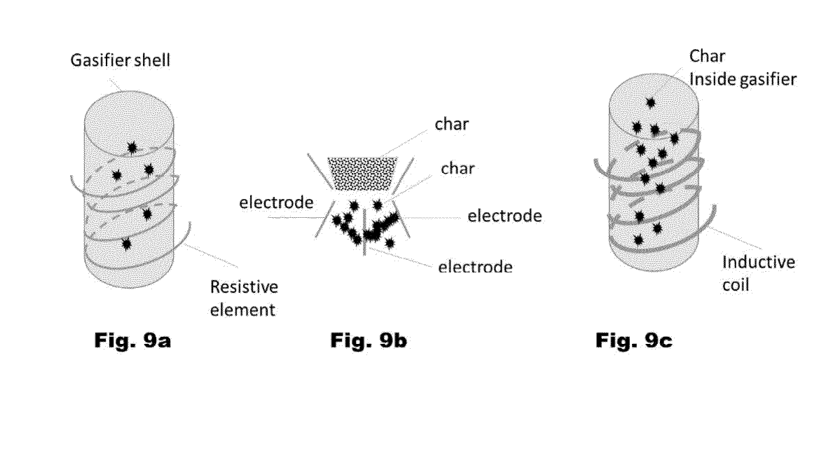

Various embodiments for heating the second gasifier are shown in FIGS. 9a-c. These embodiments include Joule heating (FIG. 9a), arc electrode heating (FIG. 9b), and inductive coil heating (FIG. 9c). Joule heating maybe readily achieved using direct current (DC) or alternating current (AC) on resistive elements such as heating jackets, wire meshes, wires, or conductive liquids. Joule heating using plasma may also be used. Arc electrode heating refers to heating of the electrically conductive char with electrodes making contact with the char particles. Either DC or AC current may be used. This heating can be implemented as the particles are entering the gasifier as shown in FIG. 9b. The carbonized charcoal exhibits low resistivity due to the 3-dimensional aromatic structure of interlinked π rings. Inductive heating entails heating the electrically conducting charcoal by electromagnetic induction, generating eddy currents within the charcoal, and leading to internal Joule heating. The charcoal would be inductively heated using a coil driven by a AC power supply operating at low voltage, high current and high frequencies. Very high frequency heating, such as that comprising radio frequency and microwave heating, may also be used.

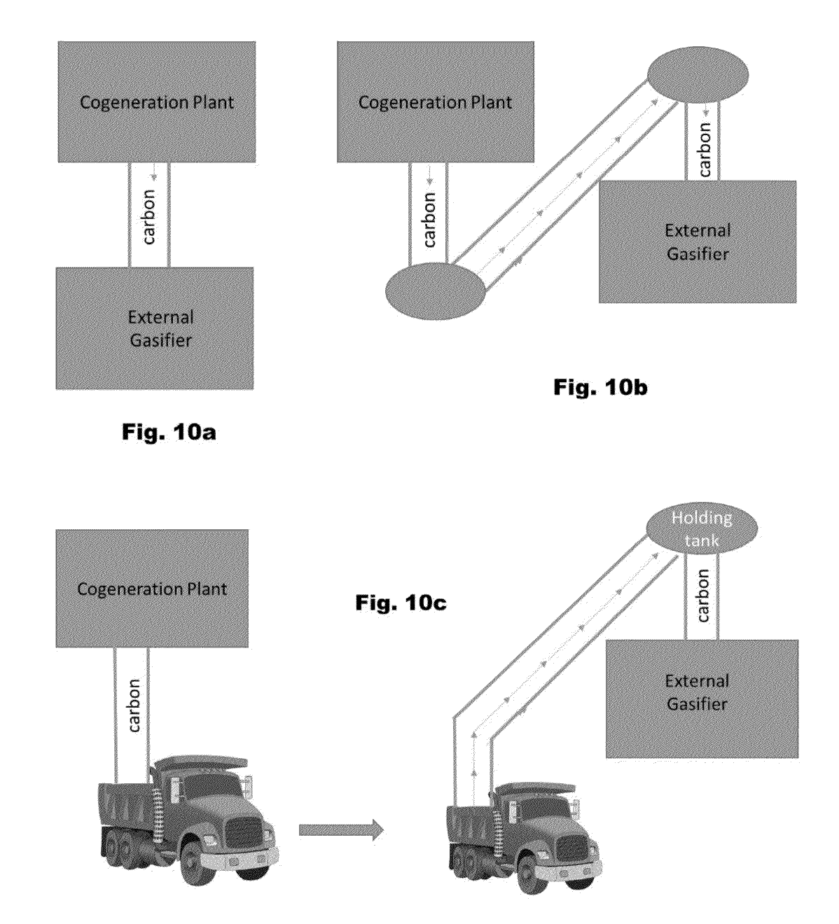

Referring again to FIG. 3, a cogeneration plant can potentially produce and transfer internally generated carbon 130 to a gasifier (referred hereafter as external gasifier). The distance between the cogeneration plant and external gasifier can vary considerably, as shown in FIGS. 10a-c. A direct conduit, such as funnel, may connect the cogeneration plant and external gasifier (FIG. 10a). In most instances, as illustrated by FIG. 10b, a means of conveying the carbon across medium distances is used. These methods may comprise technologies such as auger systems, belt conveyors, pneumatically driven systems, and vibrating conveyor systems. In other instances, as embodied in FIG. 10c, the carbon is transported along long distances in mobile equipment, such as trucks or barge boats, in order to be delivered at the external gasifier. This distance flexibility also applies to the delivery of waste heat from the cogeneration plant to the external gasifier.

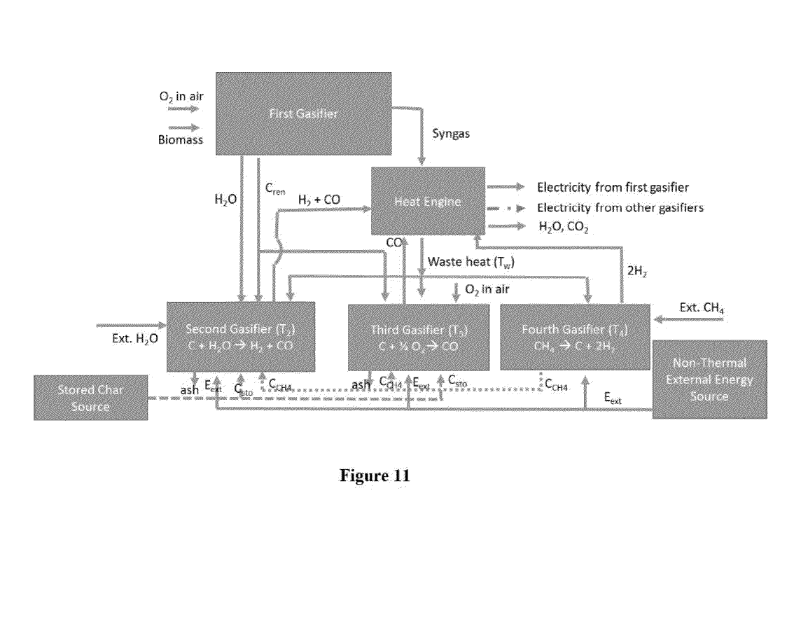

FIG. 11 illustrates an embodiment of the present disclosure using multiple external gasifiers, in which each gasifier effects a different gasification reaction and sends its own syngas or syngas component output to a central heat engine. Waste heat from the heat engine is sent to each of the gasifiers in accordance with the optimal operational temperature for the reaction. The third gasifier features a partial carbon oxidation reaction, and this reaction, as shown in Table 1, is exothermic. Consequently this gasifier would instead direct waste heat to other two gasifiers. In this embodiment each each gasifier is capable of receiving input from one or more external energy sources, as well as carbon from a stored char source. Additional sources of carbon for the second and third gasifiers are the carbon derived from the methane decomposition reaction in the fourth gasifier and the carbon from the biomass oxidation reaction in the first gasifier.

The COEP, as defines herein, is a measure of the apparent amplification of the supplied external energy implemented via stored chemical energy in the supplied char and via use of process heat. By design in the present disclosure COEP is necessarily greater than 1. The apparent amplification (COEP>1) is a result of using electricity and waste heat from the combustion process. The overall thermal efficiency of the plant is still under 100%. The value of COEP is dictated by the ratio of supplied char to supplied external energy. In some embodiments COEP can vary from 1.01 to 10. Further embodiments have values COEP values from 1.5 to 5, and still further embodiments have COEP values from 2 to 4.

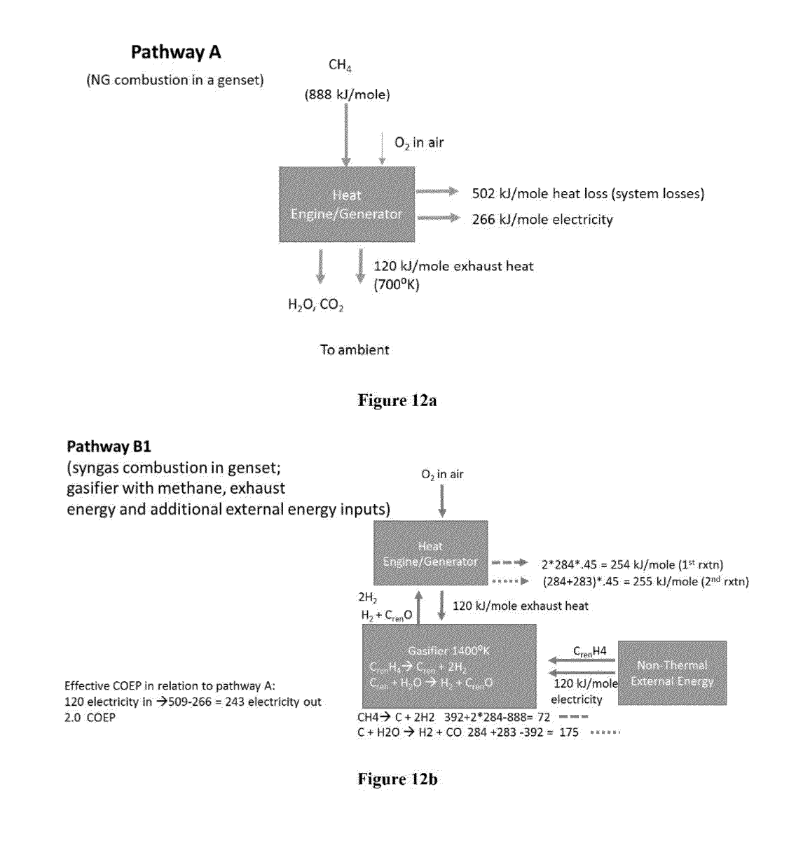

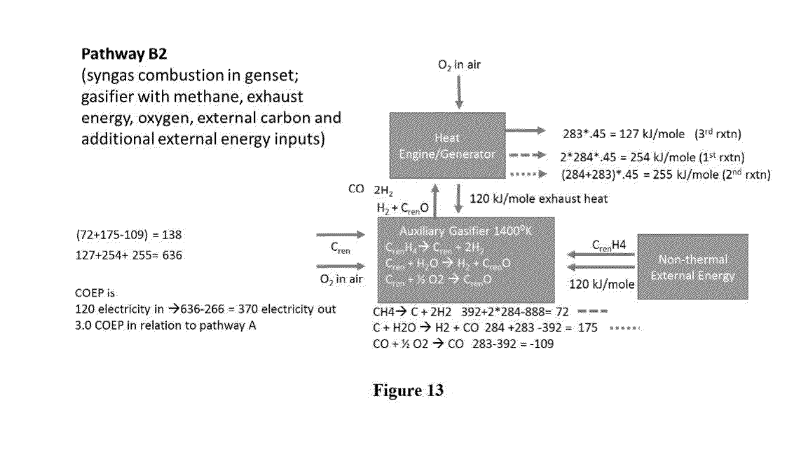

FIGS. 12a-b and FIG. 13 show simplified COEP calculations for two embodiments. In the first embodiment, shown in FIG. 12b, a cogeneration plant in the form of a internal combustion engine/generator is linked to an external gasifier operating at 1400° K. When burning natural gas, as shown in FIG. 12a, the internal combustion engine coupled to a generator converts 888 kJ/mole input energy (methane higher heating value) to carbon dioxide and water and in the process produces 266 kJ/mole electricity (efficiency of 30%) and exhaust heat at 700° K. This exhaust heat represents 120 kJ/mole energy out the tailpipe. This exhaust energy is not sufficient to power the steam gasification and methane decomposition reactions in the gasifier. The external energy source needs to provide an additional 120 kJ/mole of energy to bring the gasifier temperature to 1400° K. Once this is achieved, along with an input of renewable methane as the source of external carbon, two moles of hydrogen and a mole of hydrogen and carbon monoxide are generated from each of the gasification reactions. By producing hydrogen and carbon monoxide over natural gas, the engine is able to operate at higher compression ratios, yielding higher efficiencies in the process. Laboratory data has shown that the engine efficiency can be improved to 45% from 30% when operating at a compression ratio of 20:1 instead of 13:1. At 45% efficiency, an output of 509 kJ/mole is expected, based on the HHV values of hydrogen and carbon monoxide. This represents an increase of 243 kJ/mole (509-266 kJ/mole) in electricity production over stand alone product. The COEP is then calculated as the ratio 243 kJ/mole/120 kJ/mole, or 2.0.

In a similar manner, FIG. 13 shows an embodiment in which an additional gasification reaction occurs as a result of limited introduction of oxygen. In addition to the introduction of 120 kJ/mole external energy and renew able methane, 1 mole of renewable carbon is also introduced. The net effect is the production of 636 kJ/mole electricity at 45% efficiency. This represents an increase of 370 kJ/mole (636-266) electricity over the stand alone product. The COEP is calculated as 3.0 (ratio 370/120).

One skilled in the art will appreciate that the present disclosure can be practiced by other than the various embodiments and preferred embodiments, which are presented in this description for purposes of illustration and not of limitation, and the present disclosure is limited only by the claims that follow. It is noted that equivalents for the particular embodiments discussed in this description may practice the disclosure as well.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that may be included in the disclosure. The disclosure is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present disclosure. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

1. A method for the conversion of biomass to electricity comprising:
supplying biomass to a cogeneration plant, and utilizing waste heat from the plant in a gasifier;
wherein the gasifier also receives input from renewable energy sources in the form of electricity and/or carbon, such that the electricity output of the combined plant and gasifier exceeds the combined standalone outputs.

2. A method according to claim 1 in which the renewable energy sources comprise one or more of: solar, wind

3. A method according to claim 1 in which the biomass input to the cogeneration plant also produces a carbon input to the gasifier.

4. A method according to claim 1 in which the carbon input to gasifier comes from externally produced carbon.

5. A method according to claim 1 in which syngas produced from said gasifier is fed to a second cogeneration plant.

6. A claim according to claim 1 in which renewable electricity is used to heat the gasifier.

7. A claim according to claim 6 in which gasifier is heated externally with resistive elements or internally via biochar induction heating or arc electrode heating.

8. A claim according to claim 1 in which the carbon produced by cogeneration plant is transported via direct conduit, conveyor means, or long distance transportation means.

9. A method according to claim 1 in which a plurality of gasifiers are used to receive the waste heat.

10. A method according to claim 1 in which the coefficient of electrical performance is 1.01 or greater.

11. A system for the conversion of biomass to electricity comprising:
a cogeneration plant that produces electricity and heat; and
a gasifier that receives heat from the cogeneration plant and input from renewable energy sources in the form of electricity and/or carbon;
wherein the electricity output from the combined plant and gasifier exceeds the combined standalone electricity outputs.

12. A system according to claim 11 in which the electricity is produced from solar or wind sources.

13. A system according to claim 11 in which the carbon is charcoal.

14. A system according to claim 11 characterized by a coefficient of electrical performance greater than 1.01.

15. A system according to claim 11 using a multiple number of gasifiers.
